(19) United States
(12) Patent Application Publication
(10) Pub. No.: US 2021/0114461 A1
(43) Pub. Date: Apr. 22, 2021

(54) IMAGE BOUNDARY INDICATORS FOR A HEADS UP DISPLAY

(71) Applicant: Panasonic Automotive Systems Company of America, Division of Panasonic Corporation of North America, Peachtree City, GA (US)

(72) Inventors: PATRICK O'CONNELL, NOVI, MI (US); EDO OMANOVIC, LIVONIA, MI (US)

(73) Assignee: Panasonic Automotive Systems Company of America, Division of Panasonic Corporation of North America

(21) Appl. No.: 17/028,362

(22) Filed: Sep. 22, 2020

Related U.S. Application Data
(60) Provisional application No. 62/915,890, filed on Oct. 16, 2019.

(51) Int. Cl. B60K 35/00; G08G 1/16; G02B 27/01

(52) U.S. Cl. CPC B60K 35/00; G06K 9/00805; G02B 27/0101; G08G 1/166

(57) ABSTRACT

Examples of the present disclosure relate to a heads up display. The heads up display includes a picture generation unit configured to generate a virtual image, and boundary indicators disposed outside of an area of the picture generation unit along a perimeter of the picture generation unit. The boundary indicators include light emitting elements configured to generate a light signal to indicate the detection of a potential hazard. The heads up display also includes a controller configured to receive sensor data and activate all or a subset of the boundary indicators in response to the sensor data.

### CROSS-REFERENCED TO RELATED APPLICATIONS

This application claims benefit of U.S. Provisional Application No. 62/915,890 filed on Oct. 16, 2019, the disclosure of which is hereby incorporated by reference in its entirety for all purposes.

### FIELD OF THE INVENTION

The present disclosure generally relates to techniques for implementing a Heads Up Display (HUD) for a vehicle. More specifically, the present disclosure describes a heads up display with image boundary indicators.

### BACKGROUND

This section is intended to introduce the reader to various aspects of art, which may be related to various aspects of the present disclosure, which are described and/or claimed below. This discussion is believed to be helpful in providing the reader with background information to facilitate a better understanding of the various aspects of the present disclosure. Accordingly, it can be understood that these statements are to be read in this light, and not as admissions of prior art.

A heads up display (HUD) provides information to a user and can include projecting a virtual image. The virtual image may be projected to appear at a location viewable to a user, such as a driver, where the virtual image can be seen while the user views another area in physical space. In the example of a driver of a vehicle, the HUD may display an image that is viewable as the driver also views the road ahead, thus avoiding the distraction of taking their eyes off the road to see information traditionally displayed by a cluster and screens on a central panel.

### SUMMARY

Generally, the present techniques relate to a heads up display. The heads up display includes a picture generation unit configured to generate a virtual image, and boundary indicators disposed outside of an area of the picture generation unit along a perimeter of the picture generation unit. The boundary indicators include light emitting elements configured to generate a light signal to indicate the detection of a potential hazard. The heads up display also includes a controller configured to receive sensor data and activate all or a subset of the boundary indicators in response to the sensor data.

### BRIEF DESCRIPTION OF THE DRAWINGS

The above-mentioned and other features and advantages of the present disclosure, and the manner of attaining them, may become apparent and be better understood by reference to the following description of one example of the disclosure in conjunction with the accompanying drawings, where:

FIG. 1 is an illustration of a heads up display for a vehicle, in accordance with embodiments;

FIG. 2 is a front view of the heads up display, in accordance with embodiments;

FIG. 3 is a block diagram of an example HUD system for a vehicle, in accordance with embodiments;

FIGS. 4A, 4B, and 4C are illustrations of a light signaling technique that can be implemented by the heads up display, in accordance with embodiments;

FIG. 5 is another illustration of a light signaling technique that can be implemented by the heads up display, in accordance with embodiments;

FIG. 6 is another illustration of a light signaling technique that can be implemented by the heads up display, in accordance with embodiments; and

FIG. 7 is a process flow diagram for an example method of operating a heads up display, in accordance with embodiments.

Correlating reference characters indicate correlating parts throughout the several views. The exemplifications set out herein illustrate examples of the disclosure, in one form, and such exemplifications are not to be construed as limiting in any manner the scope of the disclosure.

### DETAILED DESCRIPTION OF EXAMPLES

One or more specific examples of the present disclosure are described below. In an effort to provide a concise description of these examples, not all features of an actual implementation are described in the specification. It can be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it can be appreciated that such a development effort might be complex and time consuming, and is a routine undertaking of design, fabrication, and manufacture for those of ordinary skill having the benefit of this disclosure.

The present disclosure describes a heads up display for a vehicle. The heads up display includes a Picture Generation Unit (PGU) that can project a virtual image to a driver by reflecting the projected image from the vehicle's windshield. The virtual image appears to the driver as a translucent image floating within the driver's field of view while looking through the windshield. In this way, the driver can view the information generated by the heads up display without looking away from the road. The heads up display described herein can be configured to deliver any suitable type of information such as vehicle speed, navigation information, radio setting, and others. The image brightness is determined by the intensity of the light generated by the picture generation unit. The image brightness can be adjusted so that the image is easily viewable by the driver, but not overwhelming to the point of being a distraction.

The heads up display is also configured to provide driver safety warnings, such as collision warnings. To ensure that warnings capture the attention of the driver, the brightness of the driver safety warnings are configured to be brighter than the images generated by the heads up display. This is accomplished by disposing a separate set of light emitting devices, such as light emitting diodes (LEDs), around the perimeter of the HUD's picture generation unit to serve as image boundary indicators. The brightness of the image boundary indicators can be controlled separately from the HUD's picture generation unit. Accordingly, increased image brightness can be achieved for safety warnings without changing the design of the picture generation unit and without the risk of overheating the picture generation unit due to the higher light intensity used for the safety warnings.

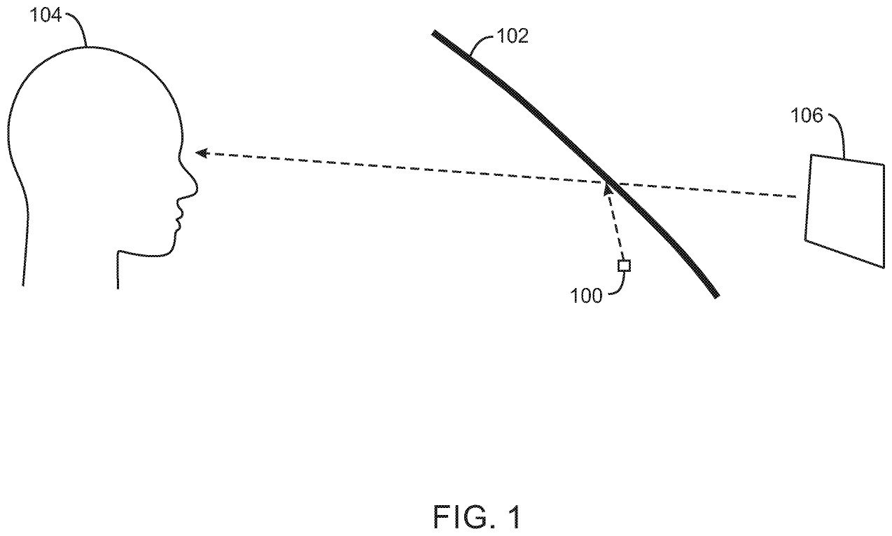

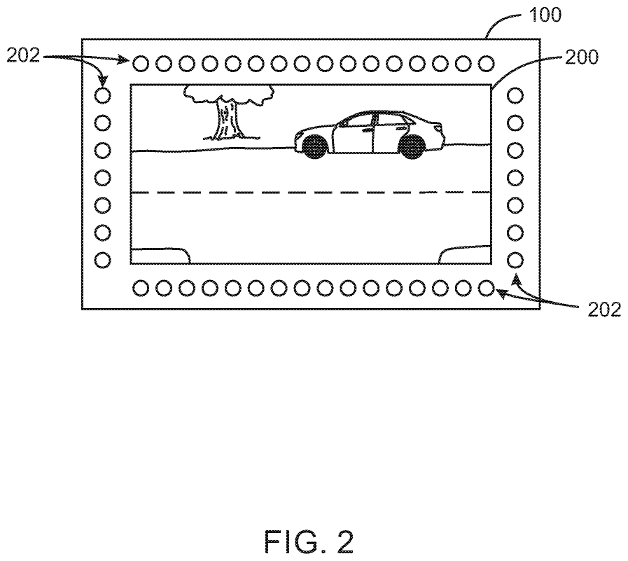

FIG. 1 is an illustration of a heads up display for a vehicle, in accordance with embodiments. The heads up display 100 can be positioned in the vicinity of the vehicle's windshield 102. For example, the heads up display 100 can be disposed within a recess in the vehicle's dashboard. The heads up display 100 is positioned so that light projected toward the windshield 102 will be reflected off of the windshield toward the driver 104. This creates a translucent virtual image 106 that may appear to be superimposed over the windshield 106 or may appear to hover outside the vehicle on the opposite side of the windshield 106. A more detailed description of the heads up display 100 is provided in relation to FIG. 2.

FIG. 2 is a front view of the heads up display, in accordance with embodiments. The heads up display 100 includes a picture generation unit 200 and image boundary indicators 202 disposed outside the perimeter of the picture generation unit 200. The picture generation unit 200 may be any type of display panel capable of generating a graphical image using a matrix of pixels. For example, the picture generation unit 200 may be a liquid crystal display (LCD), an organic light emitting diode (OLED) display, and others. The picture generation unit 200 is configured to display information to the driver through the presentation of various types of images. As used herein, the term “image” is used to refer to a display that represents the form of a person, object, scene, or information-bearing symbols. The image generated by the picture generation unit 200 may be a representation of a physical gauge, a display of numbers or text, an image captured by a camera, a navigational map, and others. For example, the picture generation unit 200 may be configured to display a virtual instrument cluster showing information about the vehicle such as vehicle speed, engine speed, gas gauge, blinker indicators, check engine light, and any other information that is usually displayed on the vehicle's instrument cluster. The picture generation unit 200 may also be configured to display an image captured by a video camera disposed on the vehicle, such as a back-up camera. The picture generation unit 200 may also be configured to display navigation information, radio settings, climate control settings, and others.

The boundary indicators 202 may include any suitable type of light emitting devices, including light emitting diodes (LEDs) and incandescent light bulbs, for example. The boundary indicators 202 are used to generate various types of light signals but do not actually generate an image, as that term is used in the present specification. The boundary indicators 202 are located outside of the area of the picture generating unit and surround the picture generation unit 200. The boundary indicators 202 shown in FIG. 2 surround the full perimeter of the picture generation unit 200. However, in some embodiments, the boundary indicators 202 may be disposed around a portion of the perimeter. In some embodiments, the boundary indicators 202 may be covered by a diffuser to diffuse the light generated by the individual light emitting devices and create the impression of a solid bar of light. Activation of one or a subset of the boundary indicators 202 will cause a light signal to be emitted, which will appear at the boundary of the virtual image generated by the picture generation unit 200.

The heads up display 100 can activate the boundary indicators 202 to present additional information to the driver such as a risk of collision or the presence of some potential hazard. For example, when the vehicle is in reverse, the heads up display 100 can use the boundary indicators 202 to indicate the presence of cross traffic or an obstacle behind the vehicle. The heads up display 100 can also use the boundary indicators 202 to indicate the presence of a traffic slowdown or a sudden reduction of speed by another vehicle in front of the driver's vehicle. The heads up display 100 can also use the boundary indicators 202 to indicate the presence of another vehicle in the driver's blind spot. The boundary indicators 202 can also be used to indicate that there is a risk of collision with a pedestrian or cross traffic at an intersection.

The brightness level of the boundary indicators 202 may be configured to be higher than the picture generation unit 200 at similar color wavelengths. For example, the picture generation unit 200 may be capable of achieving a brightness level of approximately 2000 to 2500 candela per square meter (cd/m²) for red light, whereas the boundary indicators 202 may be configured for a brightness level of more than two times that for red light, for example, 5000 to 8000 cd/m² or more. In this way, the boundary indicators 202 can achieve a brightness level more likely to attract the driver's attention while the brightness level of the picture generating unit 200 is maintained within a range that is acceptable for normal image generation and safe operation of the picture generation unit 200.

In some embodiments, the boundary indicators 202 may be activated in a way that indicates the direction of the detected hazard. As shown in FIG. 2, the boundary indicators 202 may be divided into four sets, one above the picture generation unit 200, one below the picture generation unit 200, one to the left of the picture generation unit 200, and one to the right of the picture generation unit 200. As used herein, references to the position of the boundary indicators 202 relative to the picture generation unit 200 are in reference to the position as seen by the user after the light has been reflected from the windshield.

The set of boundary indicators 202 above the picture generation unit 200 can be used to indicate a hazard in front of the vehicle, the set of boundary indicators 202 below the picture generation unit 200 can be used to indicate a hazard in behind the vehicle, the set of boundary indicators 202 to the left of the picture generation unit 200 can be used to indicate a hazard to the left of the vehicle, and the set of boundary indicators 202 to the right of the picture generation unit 200 can be used to indicate a hazard to the right of the vehicle. Additionally, different combinations of the four sets of boundary indicators can be used to indicate different directions. For example, the top set and left set may be activated simultaneously to indicate a hazard related to cross traffic in front of the vehicle and approaching from the left, etc.

Various types of information, such as seriousness or proximity of a hazard, can be conveyed by the boundary indicators 202 based on a color of the light emitting elements and whether the light emitting elements are solid or blinking. A blinking pattern or color may be used to indicate a relative distance of a hazard. For example, the blinking pattern may start as a slow blinking pattern to indicate that the hazard is relatively distant, and speed of the blinking pattern may be gradually increased as the hazard gets closer to the vehicle. Different colors may also be used to indicate the relative distance of a hazard. For example, yellow may be used to indicate that the hazard is relatively distant, whereas red may be used to indicate that the hazard is relatively close. In some embodiments, the color may be used to indicate the lack of a hazard. For example, when in reverse, the color green may be used to indicate that there are not obstacles or other hazards detected.

It will be appreciated the particular hazard scenarios and techniques for conveying hazard information described herein are only examples. Various additional techniques for conveying hazard information through the use of the boundary indicators 202 can be implemented depending on the design considerations of a particular implementation and the particular scenarios to be addressed.

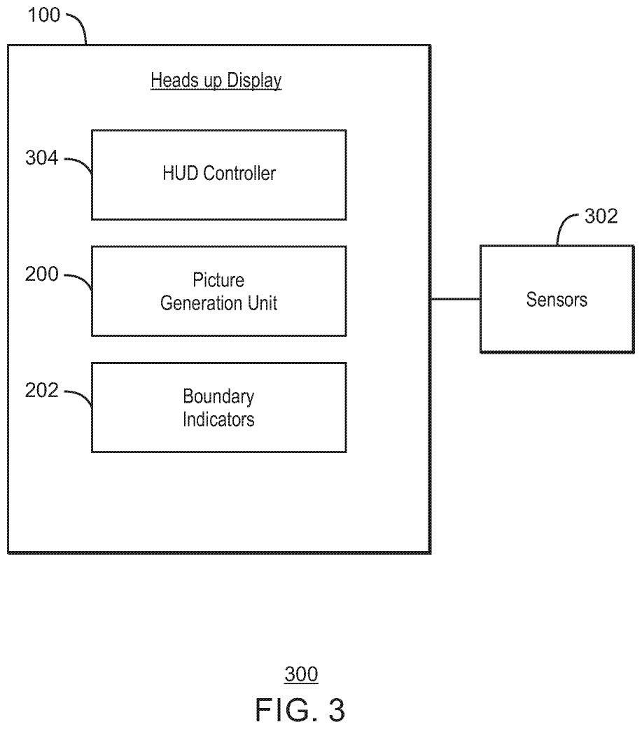

FIG. 3 is a block diagram of an example HUD system for a vehicle, in accordance with embodiments. The HUD system 300 includes the heads up display 100 coupled to one or more sensors 302. The sensors 302 are included in the vehicle and may include an electronic sensing device for generating and transmitting information to the heads up display 100. Example sensors 302 can include a sensor for detecting information about the vehicle such as vehicle speed, rotational speed of the engine, tire pressure sensors, fuel level sensors, and other sensors for collecting data that would typically be displayed in an instrument cluster. The sensors 302 can also include sensors for detecting information about the vehicles surroundings, such cameras, proximity sensors, radar and/or lidar systems, and others. The sensors 302 can also include systems for detecting radio frequency (RF) communications, for example, from other vehicles and/or roadway infrastructure. The sensors 302 may be coupled to the heads up display 100 directly, or information from the sensors 302 may be transmitted to the heads up display 100 from other processing units, such as one or more of the vehicle's Electronic Control Units (ECUs).

The heads up display 100 includes the picture generator unit 200, the boundary indicators 202, and a HUD controller 304. The HUD controller 304 may be implemented as processing hardware or a combination or hardware and software. For example, the HUD controller 304 may be implemented on a dedicated microprocessor such as an Application Specific Integrated Circuit (ASIC), as software or firmware executing on a general purpose processor, and the like. The HUD controller 304 can receive information from the sensors 302 and control the picture generation unit 200 and the boundary indicators 202 in accordance with its programming.

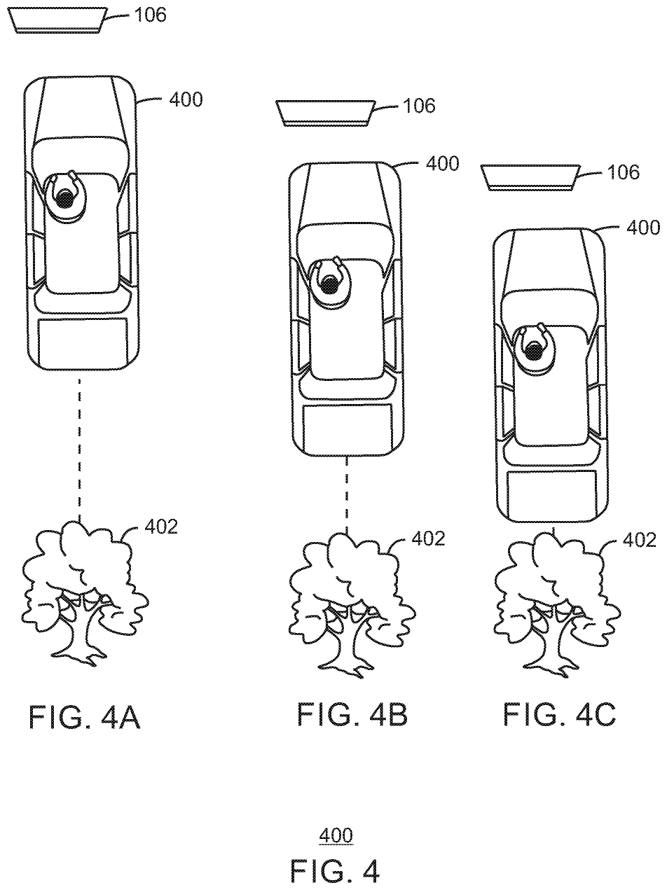

The HUD 100 projects images and light signals to the user by reflecting the projection toward the windshield, which reflects the image to the user. The HUD controller 304 can control the picture generation unit 200 to create a variety of different images, and can control the boundary indicators 202 to generate a variety of light signals that will be reflected to the user and appear at the outer edges of the image created by the picture generation unit 200. Some examples of possible light signals that can be implemented for different scenarios are described below in reference to FIGS. 4-6.

FIGS. 4A, 4B, and 4C are illustrations of a light signaling technique that can be implemented by the heads up display, in accordance with embodiments. During a backup mode, one or more sensors in the vehicle can detect whether there are any objects 402 in the path of the vehicle that could present a hazard. The backup mode may be activated upon detecting that the vehicle is in reverse gear. In some embodiments, the vehicle 400 can determine the distance to an object behind the vehicle during backup mode, and issue warnings to the driver using the boundary indicators based on the distance. In addition to the boundary indicators, the picture generation unit may also be displaying images captured by a backup camera installed in the vehicle. Together, the picture generating unit and the boundary indicators form the virtual image and light signals 106 visible to the driver.

In FIG. 4A, there is no obstacle behind the vehicle 400, meaning that no object is detected or, if an object is detected, the distance to the object is beyond a threshold distance. In this case, the heads up display may activate the boundary indicators to generate a green light below the picture generation unit, indicating to the driver that the reverse path is clear and no obstacles are detected. In some embodiments, the heads up display may also keep all of the boundary indicators inactivated, which would also indicate that the path is clear and no obstacles are detected.

As shown in FIG. 4B, the vehicle has proceeded to back up and an obstacle has been detected and is within the specified threshold for issuing a caution signal to the driver. The heads up display generates the caution signal by activating the boundary indicators below the picture generation unit to indicate the presence of the obstacle. This may be done by activating the boundary indicators or changing the color of the boundary indicators, for example, from green to yellow. In this way, the driver can be alerted to the presence of the obstacle, while informing the driver that there is still room to continue the backing maneuver.

As shown in FIG. 4C, the vehicle has proceeded to back up and the obstacle is now within a second specified threshold for issuing a new warning to the driver. For example, the heads up display can change the color of the boundary indicator from yellow to red. Accordingly, the driver can be alerted that the obstacle is now very close to the vehicle and that continuing the backing maneuver could result in a collision.

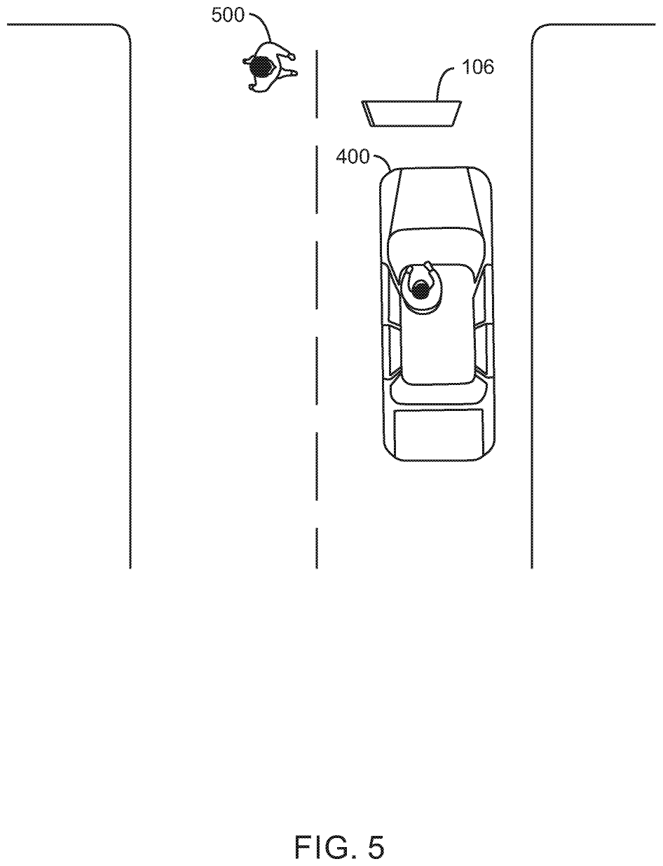

FIG. 5 is another illustration of a light signaling technique that can be implemented by the heads up display, in accordance with embodiments. In this example, the boundary indicators are used to warn the driver of the vehicle 400 about the risk of a collision due to a person 500 approaching from the side. In the illustrated example, the risk of collision is due to a pedestrian walking through a crosswalk. However, the same technique could apply to other scenarios, such as a vehicle in cross traffic passing through an intersection. In this example, the vehicle 400 has detected an object, in this case, a pedestrian approaching from the left. In response, the heads up display activates the boundary indicators to the left of the picture generation unit, as seen in the virtual image 106. The color of the boundary indicator, which may be red for example, informs the driver about the risk of collision and indicates that the driver should not move forward.

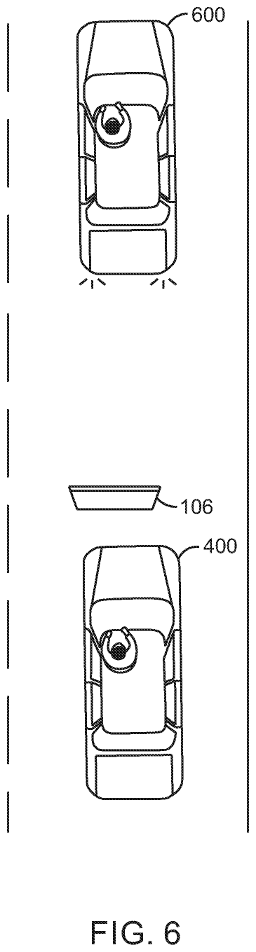

FIG. 6 is another illustration of a light signaling technique that can be implemented by the heads up display, in accordance with embodiments. In this example, the boundary indicators are used to warn the driver of a first vehicle about the risk of a collision due to a forward vehicle 600 during a driving mode. The driving mode may be activated by detecting that the vehicle is moving forward or is in a forward gear. During driving mode, forward facing sensors in the vehicle 400 can be used to determine the distance to the forward vehicle 600. The heads up display or other processing unit in the vehicle 400 can determine a safe distance for the forward vehicle 600 based on the speed of the vehicle 400 and the distance to the forward vehicle 600. If the driver is following too closely, the heads up display can issue a caution signal to the driver by activating the boundary indicators above the picture generation unit, as seen in the virtual image 106. For example, the caution signal may be indicated by activating the boundary indicators to light yellow.

Additionally, the heads up display or other processing unit in the vehicle can use the sensor information to detect a sudden drop in the speed of the forward vehicle 600. Such a drop in speed may be indicative of a sudden braking maneuver or an abrupt traffic slowdown. In such a case, the heads up display can issue a warning signal to the driver by activating the boundary indicators above the picture generation unit. For example, the caution signal may be indicated by activating the boundary indicators to light red.

It will be appreciated that the example signaling techniques described in relation to FIG. 4 to FIG. 6 can be modified in accordance with the design considerations of a particular implementation. For example, warnings and caution signals may be generated using any suitable combination of colors or blinking patterns. Additionally, any suitable combination of boundary indicators may be activated to convey the warnings and caution signals in addition to the specific examples provided above.

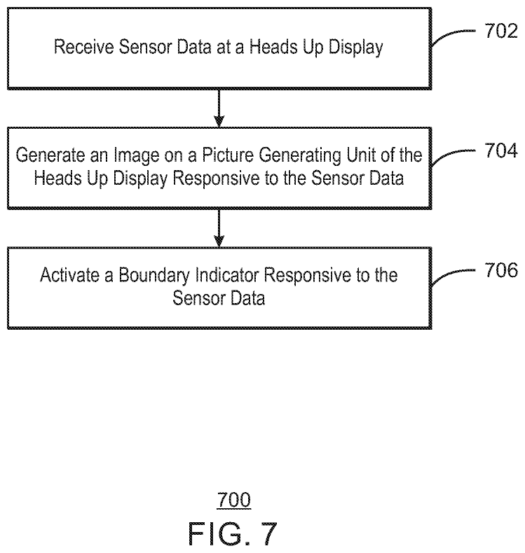

FIG. 7 is a process flow diagram for an example method of operating a heads up display, in accordance with embodiments. As described above, the heads up display includes a picture generation unit and boundary indicators disposed around a perimeter of the picture generation unit. The method 700 may be performed by logic implemented in the heads up display alone or combination with other processing units in a vehicle. The logic is embodied in hardware, such as logic circuitry or one or more processors configured to execute instructions stored in a non-transitory, computer-readable medium. The process may begin at block 702.

At block 702, sensor data is received at the heads up display. The sensor data is received from one or more sensors and/or processing units disposed in the vehicle, and can include any combination of data, such as proximity and distance data, image data, wireless communication data, and others. The sensor data may be raw data received directly from the sensors or may be pre-processed by other processing units within the vehicle.

At block 704, an image is generated at the picture generation unit in response to the sensor data. The image may be an image of a scene outside of the vehicle as captured by a camera, vehicle status information such as instrument cluster data, and others.

At block 706, a boundary indicator is activated in response to the sensor data. The boundary indicator may be activated in response to the detection of a potential hazard, such a risk of collision, or to indicate the absence of a hazard. Activation of the boundary indicator may include controlling the color of the light emitting devices included in the boundary indicator, controlling a blinking pattern of the light emitting devices, or otherwise controlling the visual appearance of the boundary indicator. Any suitable combination of boundary indicators may be activated depending on the information to be conveyed to the driver, such as the direction of the hazard.

The method 700 should not be interpreted as meaning that the blocks are necessarily performed in the order shown. Furthermore, fewer or greater actions can be included in the method 700 depending on the design considerations of a particular implementation.

While the invention may be susceptible to various modifications and alternative forms, specific embodiments have been shown by way of example. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A heads up display, comprising:
a picture generation unit configured to generate a virtual image;
boundary indicators disposed outside of an area of the picture generation unit along a perimeter of the picture generation unit, wherein the boundary indicators comprise light emitting elements configured to generate a light signal to indicate the detection of a potential hazard;
a controller configured to receive sensor data and activate all or a subset of the boundary indicators in response to the sensor data.

2. The heads up display of claim 1, wherein a location of the subset of boundary indicators relative to the picture generation unit is to indicate a direction of the potential hazard.

3. The heads up display of claim 1, wherein a color of the subset of boundary indicators is to indicate a severity of the potential hazard.

4. The heads up display of claim 1, wherein a brightness level of the boundary indictors, when activated, is greater than two times a brightness level of the picture generation unit.

5. The heads up display of claim 1, wherein a brightness level of the boundary indictors, when activated, is greater than 5000 candelas per square meter.

6. The heads up display of claim 1, wherein the boundary indicators surround a full perimeter of the picture generation unit.

7. The heads up display of claim 1, wherein the sensor data comprises data to be received from one or more of:
a proximity sensor disposed in the vehicle;
a camera disposed in the vehicle; and
a wireless communication circuitry disposed in the vehicle.

8. The heads up display of claim 1, wherein the controller is configured to activate a backup mode when the vehicle is in a reverse gear and, during the backup mode, detect a distance to an obstacle in a path of the vehicle, and control a color of the subset of boundary indicators to indicate the distance to the obstacle.

9. The heads up display of claim 1, wherein the controller is configured to activate a forward mode when the vehicle is moving forward and, during the forward mode, activate the subset of boundary indicators to indicate a risk of collision with another vehicle in front of the vehicle.

10. The heads up display of claim 1, wherein the potential hazard is a risk of collision due to an object approaching from the side, and the controller is activate the subset of boundary indicators on a same side of the picture generation unit as the direction of the object.

11. A method of operating a heads up display, comprising:
receiving sensor data at the heads up display;
generating an image on a picture generation unit responsive to the sensor data; and
activating a boundary indicator responsive to the sensor data to indicate the detection of a potential hazard, wherein the boundary indicator comprises light emitting elements disposed outside of an area of the picture generation unit along a perimeter of the picture generation unit.

12. The method of claim 11, wherein activating the boundary indicator comprises activating the boundary indicator that is positioned, relative to the picture generation unit, in a same direction as the potential hazard.

13. The method of claim 11, wherein a brightness level of the boundary indictor, when activated, is greater than two times a brightness level of the picture generation unit.

14. The method of claim 11, wherein a brightness level of the boundary indictor, when activated, is greater than 5000 candelas per square meter.

15. The method of claim 11, wherein receiving the sensor data comprises receiving the sensor data from one or more of:
a proximity sensor disposed in the vehicle;
a camera disposed in the vehicle; and
a wireless communication circuitry disposed in the vehicle.

16. A vehicle, comprising:
a windshield;
a heads up display configured to generate a virtual image by projecting an image to be reflected by the windshield, wherein the heads up display comprises:
a picture generation unit configured the project the image; and
boundary indicators disposed outside of an area of the picture generation unit along a perimeter of the picture generation unit, wherein the boundary indicators comprise light emitting elements configured to generate a light signal to indicate the detection of a potential hazard.

17. The vehicle of claim 16, wherein a subset of the boundary indicators are activated in response to a detection of a potential hazard, wherein the subset of the boundary indicators are positioned, relative to the virtual image, in a same direction as the potential hazard.

18. The vehicle of claim 16, wherein a brightness level of the boundary indictors, when activated, is greater than two times a brightness level of the picture generating unit.

19. The vehicle of claim 16, wherein a brightness level of the boundary indictors, when activated, is greater than 5000 candelas per square meter.

20. The vehicle of claim 16, comprising sensors to deliver sensor data to the heads up display, the sensors comprising one or more of:
a proximity sensor;
a camera; and
a wireless communication circuitry.
